(19) United States
(12) Patent Application Publication
(10) Pub. No.: US 2013/0063575 A1
(43) Pub. Date: Mar. 14, 2013

(54) SYSTEM AND METHOD FOR VIEWING ANGLE COMPENSATION FOR POLARIZED THREE DIMENSIONAL DISPLAY

(71) Applicants: Yunwei Jia, Thornhill (CA); Steven Nashed Hanna, Richmond Hill (CA)

(72) Inventors: Yunwei Jia, Thornhill (CA); Steven Nashed Hanna, Richmond Hill (CA)

(73) Assignee: BROADCOM CORPORATION, Irvine, CA (US)

(21) Appl. No.: 13/232,208

(22) Filed: Sep. 14, 2011

(51) Int. Cl. H04N 13/04

(52) U.S. Cl. 348/51; 348/E13.075

(57) ABSTRACT

A method and system for reducing crosstalk for a three dimensional display includes a processor in communication with a display configured to display three dimensional video. The processor is configured to determine a viewing angle between a section of the three dimensional display and a viewpoint of the three dimensional display, generate a crosstalk compensation function for the section of the three dimensional display, wherein the crosstalk function compensates for the crosstalk at the viewing angle, and apply the crosstalk compensation function to the section of the three dimensional display to reduce the crosstalk of the three dimensional display from the viewing angle.

### BACKGROUND

1. Technical Field

This disclosure relates to systems and methods for reducing crosstalk of a three dimensional display as perceived by a viewer.

2. Related Art

Human beings achieve three dimensional perception of a scene by viewing it from two slightly different perspectives, one from the left eye and the other from the right eye. As each eye has a slightly different viewing angle from observed objects, the brain of the viewer automatically differentiates the viewing angles and is able to generally determine where the object is in a three dimensional space.

In modern three dimensional stereoscopic displays, two different views of a scene are presented to the viewer, one for the left eye and the other for the right eye, in order to simulate how human beings achieve three dimensional perception in the real world. Generally, three dimensional video can be achieved by utilizing

Polarized displays with passive polarized glasses. For this type of display, the left view and the right view are presented on the display at the same time in a spatial-multiplexing manner. As an example, in a line interleaving three dimensional display format, the odd lines on a display can be for the left view and the even lines on the display for the right view. An optical filter is used on the display to polarize the left view pixels in one orientation, and the right view pixels in its orthogonal orientation. For example, the left view pixels can be linearly polarized at 45° and the right view pixels can be linearly polarized at 135°. The viewer then needs to wear a pair of passive glasses with a left lens being polarized in the same way as the left view pixels on the display and the right lens being polarized in the same way as the right view pixels on the display. In this way, the viewer can see both views simultaneously with the left eye seeing the left view and the right eye seeing the right view and thus a three dimensional scene is reconstructed in the brain.

However, using passive polarized glasses can result in crosstalk as the angle from which the viewer is looking at the display changes. Crosstalk generally refers to leakage of the left image channel into the right eye view and vice versa. For example, at one viewing angle, the viewer may experience small amounts of crosstalk which would provide a minimal ghosting effect perceived by the viewer. However, at a different angle, the viewer may experience significant crosstalk, resulting in significant ghosting making the three dimensional images more difficult to visualize.

### BRIEF DESCRIPTION OF THE DRAWINGS

The system may be better understood with reference to the following drawings and description. In the figures, like reference numerals designate corresponding parts throughout the different views.

FIG. 1 illustrates a system for reducing crosstalk for a three dimensional display;

FIGS. 2 and 3 illustrate the display and the positioning of a viewer relative to the display;

FIG. 4 shows an example of logic that a processor may execute to reduce crosstalk for the three dimensional display; and

FIG. 5 illustrates a display having multiple portions, wherein each portion utilizes a different crosstalk compensation function to reduce crosstalk.

### DETAILED DESCRIPTION

Referring to FIG. 1, a system 10 for reducing crosstalk for a three dimensional display is shown. As its primary components, the system 10 includes a three dimensional display 12 having a viewing area 14, a processor 16 in communication with the three dimensional display 12 and a storage device 18 in communication with the processor 16. The system 10 may also include one or more multiple cameras 21 that are in communication with the processor 16. The processor 16 may obtain signals (e.g., image frames) from the cameras 21 and may identify and determine (e.g., using facial recognition algorithms) the location of a viewer who has a certain viewpoint of the three dimensional display 12.

As one example, the three dimensional display 12 may be a polarized three dimensional display. A polarized three dimensional display is configured to project two images superimposed on the display area 14 of the three dimensional display 12 at the same time. Generally, two images are projected superimposed onto the display area 14 of the three dimensional display 12 through orthogonal polarizing filters. For example, pixels forming a left view image can be linearly polarized at 45 degrees and pixels forming a right view image can be linearly polarized at 135 degrees. In order for a viewer to see the left view image with their left eye and the right view image with their right eye, the viewer may wear a pair of passive glasses 20 with the left lens polarized in the same way as the left view image pixels on the display 12 and the right lens being polarized in the same way as the right view image pixels on the display 12. By so doing, the viewer can see both simultaneously—with the left eye seeing the left view image and the right eye seeing the right view image.

The processor 16 may include an instruction set 22 having instructions that are executed by an execution unit 24 of the processor 16. It should be understood that the processor 16 may be a single processor or may be multiple processors located within the same package or may be multiple processors that are in communication with each other and distributed on one or more circuit boards.

Alternatively, the instruction set 22 may be stored in the memory device 18, and may be read and executed by the processor 16 from the memory device 18. The memory device 18 may be any suitable memory device capable of storing digital information. For example, the memory device 18 may be a solid state memory device, a magnetic memory device, such as a hard disk, or an optical memory device. Further, the memory device 18 may be incorporated into the processor 16 or may be located separate from the processor 16. Further, the memory device 18 may be in direct physical and electrical communication with the processor 16, but may also be remote from the processor 16 and may communicate with the processor 16 through a wired or wireless communication network.

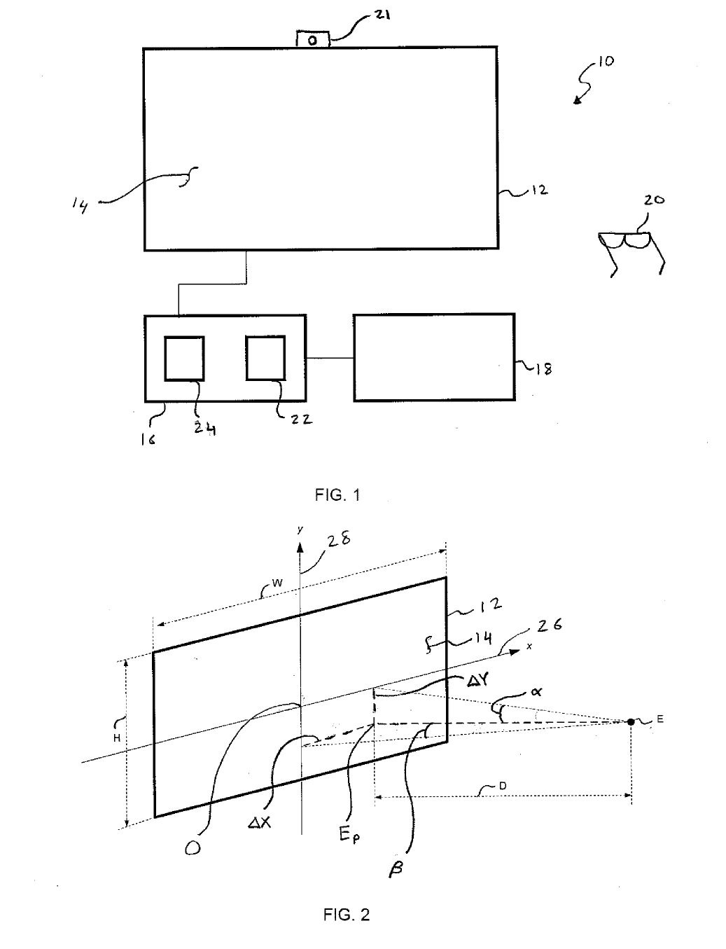

Referring to FIG. 2, the display 12 is shown in a slightly angled position. The display area 14 has a width W and a height H and has a center O. The width W extends along the x-axis 26, while the height extends along the y-axis 28. The display area 14 can be viewed from a variety of different viewpoints including viewpoint E. The viewpoint E is projected on the display area 14 of the display 12 at point Eₚ. The viewpoint E is a distance D from the projection point Eₚ on the display area 14 of the display 12. The horizontal offset along the x-axis 26 is denoted by ΔX and the vertical offset along the y-axis 28 is denoted by ΔY from the projection point Eₚ from the center O of the display area 14 of the display 12.

The vertical viewing angle of the viewpoint E relative to the center O of the display area 14 is referred to as the center vertical viewing angle α (alpha) and is defined by the equation as α=a tan (ΔY/D). Similarly, the center horizontal viewing angle β (beta) can be defined as β=a tan (ΔX/D). The viewing distance D and the center viewing angles (α, β) may be automatically estimated by the processor 16, by the cameras 21 that are in communication with the processor 16, or by both working together. The cameras 21 may be integral with the display 12, or may be positioned in other locations.

As such, the positioning of the viewpoint E relative to the display 12 is fully described by the three parameters of distance D, center viewing angle α, and center horizontal viewing angle β. Note also that in the most general case, each of these three parameters (D, α, β) may be different for the left eye and the right eye of the viewer from the viewpoint E. However, in the normal viewing positions, one may reasonably assume that the distance D and the center vertical viewing angle α are the same for the left and right eyes and that the center horizontal viewing angle β is slightly different for each eye by some predefined horizontal angular difference. The location of the viewpoint E, and the individual eyes, may be parameterized in other coordinate systems.

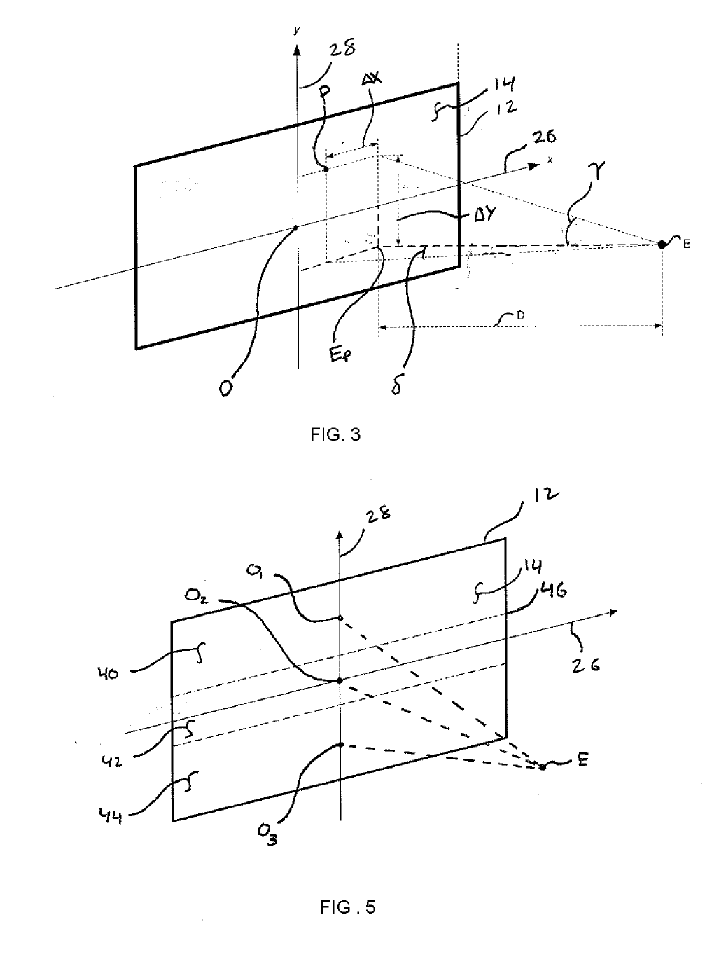

The center viewing angles α and β are defined using the center O of the display area 14 of the display 12 as a reference; however, any reference point can be used, for example an arbitrary single pixel within the display area 14. For example, referring to FIG. 3, the viewpoint E of any pixel P on the display surface of the display 12 can be defined by the pixel vertical viewing angle γ (gamma) and the pixel horizontal viewing angle δ (delta). As such, the pixel vertical viewing angle γ may be expressed by the equation as γ=a tan (ΔY/D). Similarly, the pixel horizontal viewing angle δ may be expressed as δ=a tan (ΔX/D).

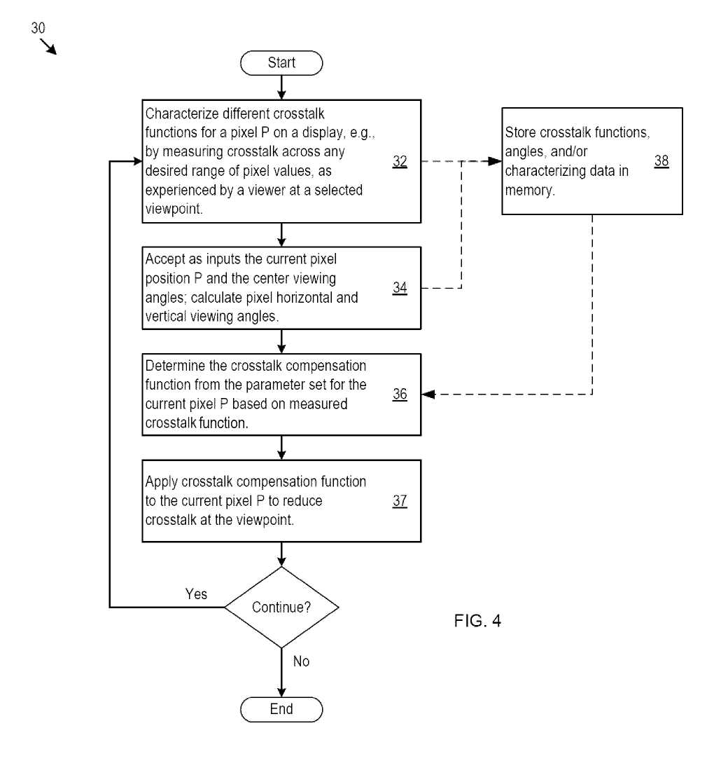

As stated in the previous paragraphs, FIG. 1 discloses a system 10 for reducing crosstalk for the three dimensional display 12. The processor 16 executes the instruction set 22 to implement a method for reducing crosstalk for the three dimensional display 12 from a viewpoint, such as viewpoint E shown in FIGS. 2 and 3. FIG. 4 shows an example of logic 30 that the instruction set 22 may implement to reduce crosstalk on the display 12.

Before presenting the left view image and right view image to the display 12, the system 10 may pre-distort the images in such a way that, when the anticipated crosstalk occurs, the perceived images by the viewer match as closely as possible to the original (undistorted) left view image and right view image. Specifically, let L be a left view image and R be its corresponding right view image. For the left eye, L is the “intended view” and R is the “unintended view”, and vice versa for the right eye. Let Φ (U, I) be a function that gives the amount of crosstalk from an unintended view U to an intended view I. It is assumed that the crosstalk is additive to the original images. For example, if the pair (L, R) is presented to the display, the viewer will perceive L′ on the left eye and R′ on the right eye, where

L′=L+Φ(R, L),

R′=R+Φ(L, R). (Eq. 1)

If the crosstalk function Φ is specifically known, one can try to find a pair of images (L″, R″) such that

L′″=L″+Φ(R″, L″)=L,

R′″=R″+Φ(L″, R″)=R. (Eq. 2)

Therefore, for the viewer, with crosstalk considered, the pre-distorted images (L″, R″) produce the perceived image pair (L′″, R′″) which is what would have been achieved from the original image pair (L, R) without crosstalk.

Note that (Eq. 2) may not be always achievable, and in such cases, one may try to find the pair (L″, R″) such that (Eq. 2) is approximated as closely as possible, or to within whatever pre-determined distortion threshold is selected. For example, one may try to find the pair (L″, R″) such that the following term is minimized:

(L″,R″)=argmin_{(L″,R″)}{∥L″+Φ(R″,L″)−L∥+∥R″+Φ(L″,R″)−R∥} (Eq.3)
where ∥x∥ is the first-degree or second-degree norm of x.

With reference to FIG. 4, the processor 16 characterizes different crosstalk functions for a pixel P on the display 12. The measured crosstalk functions give the amount of crosstalk that is normally displayed by the pixel P from the viewing position E. As will be explained in the paragraphs that follow, a crosstalk compensation function will correct for the crosstalk that would normally be experienced by a viewer at viewpoint E, and that may be given or estimated by the measured crosstalk functions.

In the characterization step, in the general case, one needs to measure the following crosstalk function: Φ (U, I, D, α, β, γ, δ) for each position P on the display, where:
U is an unintended pixel value;
I is an intended pixel value;
α and β are the horizontal and vertical viewing angles respectively, relative to the center of the display;
γ and δ are the horizontal and vertical viewing angles respectively, relative to the position P.

In order to accomplish this, a measurement is made of the crosstalk experienced by a viewer at viewpoint E. At least one of the distance D, the center vertical viewing angle α, the center horizontal viewing angle β, the pixel vertical viewing angle γ, and the pixel horizontal viewing angle δ may be known. During this characterization, any range of pixel values that are on the display 12 or that the display 12 may generate may be analyzed. For example, if the display 12 is a 10-bit display that generates 1024 different colors, then the unintended crosstalk function and the intended view may by analyzed for each pixel value from 0 to 1,023. Furthermore, the characterization may be done across any desired range of the five parameters (D, α, β, γ, δ). To that end, the characterization process may define upper and lower bounds of each of the five parameters over which the characterization is performed (e.g., plus or minus 10% of alpha, or plus or minus 20 pixels in D).

Due to the continuous nature of these parameters, the parameter space may be sampled at any desired discrete intervals to obtain a desired range for the measurements used in the characterization process. The sampling may have a density that permits accurate interpolation of the measured crosstalk to any pre-selected measure of accuracy. The characterization may be performed by the processor 16 or may be performed off site by a calibration system, and stored in the memory device 18, so that the processor 16 can easily retrieve the characterization data or crosstalk functions from the storage device 18 (38).

The processor 16 performs a calculation of the viewing angle or angles from the current pixel P (34). In order to do this, the processor 16 may, for example, accept as inputs the current pixel position P, the center viewing angles α and β, the viewing distance D, and the size of the display W and H. The processor 16 may then determine the viewing angles γ and δ for the current pixel according to the geometry shown in FIG. 3 or any other technique.

The processor 16 determines the crosstalk compensation function for the current pixel P (36). The processor 16 may generate the crosstalk compensation function from the parameter set for the current pixel P based on the measured crosstalk function (that may be stored in and retrieved from the memory device 18). Note that the parameter set for the current pixel currently under analysis does not correspond to a measurement point in the parameter space that is already available in the memory device 18, the processor 16 may interpolate from one or more neighboring parameter points to produce the crosstalk compensation function for the current pixel

The processor 16 or other calibration system may determine the crosstalk compensation function by measuring crosstalk that occurs in a controlled environment, such as a laboratory environment, then applying different crosstalk compensating functions to the pixel. When the amount of crosstalk is reduced by a selected compensation level, the crosstalk compensation function for that pixel may be considered determined, and then stored in the memory device 18. The processor 16 may chose the appropriate crosstalk compensation function, according to the parameters, to apply to the display 12 to eliminate or reduce crosstalk (e.g., ghosting) that would be experienced from a viewer from viewpoint E. In other words, the processor 16 applies the crosstalk compensation function to the current pixel P (37), as described above, and crosstalk is effectively reduced at viewpoint E.

To provide further explanation, assume I am the intended signal and U is the unintended signal. For a particular point at the parameter surface to the crosstalk function, one can measure the perceived brightness and denote it as a function of multiple parameters: f (U, I, D, α, β, γ, δ). From here, the unintended signal U is set to 0, and the intended signal I is varied within its available range while keeping all other parameters unchanged, and a measurement of the perceived brightness is taken and denoted as f (0, I′, α, β, γ, δ). For a certain intended signal I′, if:

f(U,I,D,α,β,γ,δ)=f(0,I′,D,α,β,γ,δ),

Then the crosstalk function at this particular point is:

Φ(U,I,D,α,β,γ,δ)=I′−I.

Note that it is assumed in the above that: (1) the crosstalk from the unintended signal (U) to the intended signal is additive, and (2) the crosstalk from an unintended signal of 0 to any intended signal I is 0.

In another embodiment, the inverse of each of the crosstalk functions Φ (U, I, D, α, β, γ, δ) for {U, I} may be obtained, and the inverse functions stored into memory for later use. Specifically, for each pair of {U, I}, (Eq. 3) may be solved with (L, R) being replaced by (U, I) and {L″, R″} becoming {U″, I″}. The solution {U″, I″} may be stored into the memory device 18 for later use. At (36), the same operations may be carried out as before, except that they are performed on the inverse functions. At (37), the processor 16 may map an input pair (U, I) to an output pair {U″, I″}. The inversion may be carried out offline to reduce, for example, the complexity of online operations.

In another embodiment, it may be assumed that the crosstalk characteristics of the display 12 are roughly invariant along the horizontal dimension, and therefore remove the dimensions of the horizontal viewing angles β and δ from the crosstalk function. In such cases, the processing for both eyes may be identical, i.e., the processing with left view as unintended and right view as intended is the same as that with right view as unintended and left view as intended. Further, in another embodiment, it may be assumed that the crosstalk characteristics of the display 12 are roughly invariant over the entire display, and therefore remove the dimensions of γ and δ from the crosstalk function. In such cases, the processing may be uniform over the entire display. Note also that the characterization may be done offline, and the resultant crosstalk functions may be stored in memory for later use.

Referring to FIG. 5, instead of determining a crosstalk compensating function for multiple pixels to a particular viewpoint, it is also possible to generally determine the crosstalk at a viewpoint for a section of the display 14. By so doing, processing demand can be reduced, as the crosstalk compensation function can be determined for a section of the display area 14 of the display 12 that includes as many pixels as desired, rather than for every pixel.

In the example shown in FIG. 5, the display area 14 of the display 12 is divided into three portions 40, 42, and 44. The three portions 40, 42, and 44 are horizontal portions extending along the x-axis 26, but it should be understood that the three portions 40, 42, and 44 may be vertical portions or may take any size or shape. Further, it should be understood that while three portions are described, there may be any number of portions or just one portion.

Here, the viewpoint E has three separate viewing angles to the centers O₁, O₂, and O₃ of portions 40, 42, and 44, respectively. From viewpoint E, three parameters (D, α, β) can be determined for each portion 40, 42, and 44. Using at least one of these three parameters (D, α, β), the processor 16 can determine the crosstalk experienced by a viewer from viewpoint E for each portion 40, 42, and 44. From there, the processor 16 can then apply three separate crosstalk compensation functions to the pixels forming each of the three portions 40, 42, and 44 of the display area 14. While, in this example, each pixel of each portion of the three portions 40, 42, and 44 does not receive a customized crosstalk compensation function, the processing load on the processor 16 will be greatly reduced while still reducing crosstalk experienced by a viewer from viewpoint from viewpoint E. In another implementation, one may assume that the crosstalk characteristics of the display are roughly invariant to the viewing distance, and therefore one may remove the dimension of the viewing distance from the crosstalk function.

Furthermore, the processor 16 may be further configured to scale or weighted average (linearly or non-linearly) the crosstalk compensation functions applied to the portions 40, 42, and 44. The scaling or weighing may be a function of the distance from an adjacent portion, and may provide a smooth transition to another crosstalk compensation function (e.g., in the adjacent portion). For example, assume that the crosstalk compensation function of portion 40 is 100, the crosstalk compensation function of portion 42 is 200, and the crosstalk compensation function of portion 44 is 300. Each portion 40, 42, and 44 has multiple rows of pixels. Moving through the rows of pixels in a particular portion and approaching another portion, the crosstalk compensation function will scale. For example, pixels that are located in rows nearest a border 46 between the first section 40 and the second section 42 will have a crosstalk compensation function of approximately 150, which is the average between the crosstalk compensation function of portions 40 and 42. As each row of pixels proceeds further away from the border 46 and into portion 40, the crosstalk compensation function will be scaled to eventually approach 100, e.g., at the center row of pixels in portion 40 and continuing to decrease. In like manner, as each row of pixels proceeds further away from the border 46 and into portion 42, the crosstalk compensation function will be increased in a scaling fashion and eventually approach 200, e.g., at the center of the portion 42 and continuing to increase further from that until the function reaches 250 at the border between portions 42 and 44.

In another embodiment of this invention, the viewing distance D and the center viewing angles {α, β} may be automatically estimated by utilizing one or more cameras 21 embedded in the three dimensional display 12.

One way of using the present system is to allow the user to program the optimal crosstalk reduction setting for a display according to his/her viewing situations. For example, a 3D test pattern may be shown to the viewer together with a slider whose different positions correspond to different crosstalk functions. By changing the positions in the sliding bar, the test pattern is processed by different crosstalk functions. The viewer can then choose the best one (i.e., with minimal ghosting) for his/her current viewing situation.

This system may be used in production line of displays to pre-correct (or pre-program) each display panel on the production line. It is expected that the panel from a production line may still have different crosstalk characteristics due to imperfection of the production process. It may be possible to in-corporate the present invention into the production process, in which the crosstalk characteristics is automatically measured for each panel, and a corresponding crosstalk reduction setting is programmed for each panel for a normal viewing situation.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A method for reducing crosstalk for a three dimensional display, the method comprising:
determining a viewing angle between a section of the three dimensional display and a viewpoint of the three dimensional display;
generating a crosstalk compensation function for the section of the three dimensional display, wherein the crosstalk function compensates for the crosstalk at the viewing angle; and
applying the crosstalk compensation function to the section of the three dimensional display to reduce the crosstalk of the three dimensional display from the viewing angle.

2. The method of claim 1, where determining the viewing angle comprises determining a vertical viewing angle, a horizontal viewing angle, or both a vertical viewing angle and horizontal viewing angle.

3. The method of claim 2, where determining a vertical viewing angle further comprises:
determining a reference point within the three dimensional display; and
determining the viewing angle from the reference point to the viewpoint.

4. The method of claim 3, where determining a reference point comprises determining a central point of the section within the three dimensional display.

5. The method of claim 3, where determining a reference point comprises determining a central point of the three dimensional display as a whole.

6. The method of claim 1, wherein the section further comprises two adjacent portions.

7. The method of claim 6,
where determining a viewing angle comprises:
determining a first viewing angle between the first adjacent portion and the viewpoint;
determining a second viewing angle between the second adjacent portion and the viewpoint;
where generating a crosstalk compensation function comprises:
generating a first crosstalk compensation function for the first adjacent portion to compensate for crosstalk at the first viewing angle;
generating a second crosstalk compensation function for the second adjacent portion to compensate for crosstalk at the second viewing angle;
applying the first crosstalk compensation function to the first adjacent portion; and
applying the second crosstalk compensation function to the second adjacent portion.

8. The method of claim 7, further comprising scaling the first crosstalk compensation function according to distance from the second adjacent portion to provide a smooth transition to the second crosstalk compensation function.

9. A system for reducing crosstalk for a three dimensional display, the system comprising:
a display configured to display three dimensional video; and
a processor in communication with the display, the processor being configured to determine a viewing angle between a section of the three dimensional display and a viewpoint of the three dimensional display, generate a crosstalk compensation function for the section of the three dimensional display, wherein the crosstalk function compensates for the crosstalk at the viewing angle, and apply the crosstalk compensation function to the section of the three dimensional display to reduce the crosstalk of the three dimensional display from the viewing angle.

10. The system of claim 9, where the processor is further configured to determine a vertical viewing angle, a horizontal viewing angle, or both a vertical viewing angle and horizontal viewing angle.

11. The system of claim 10, where the processor is further configured to determine a reference point within the three dimensional display, and determine the viewing angle from the reference point to the viewpoint.

12. The system of claim 11, where the reference point is a central point of the section within the three dimensional display.

13. The system of claim 11, where the reference point is a central point of the three dimensional display as a whole.

14. The system of claim 9, wherein the section further comprises two adjacent portions.

15. The system of claim 14,
where the processor is further configured to
determine a first viewing angle between the first adjacent portion and the viewpoint;
determine a second viewing angle between the second adjacent portion and the viewpoint;
where generating a crosstalk compensation function comprises:
generate a first crosstalk compensation function for the first adjacent portion to compensate for crosstalk at the first viewing angle;
generate a second crosstalk compensation function for the second adjacent portion to compensate for crosstalk at the second viewing angle;
apply the first crosstalk compensation function to the first adjacent portion; and
apply the second crosstalk compensation function to the second adjacent portion.

16. The system of claim 15, wherein the processor is further configured to scale the first crosstalk compensation function according to distance from the second adjacent portion to provide a smooth transition to the second crosstalk compensation function.

17. A system for reducing crosstalk for a three dimensional display, the system comprising:
a display configured to display three dimensional video; and
a processor in communication with the display, the processor being configured to determine a viewing angle between a section of the three dimensional display and a viewpoint of the three dimensional display, generate a crosstalk compensation function for the section of the three dimensional display, wherein the crosstalk function compensates for the crosstalk at the viewing angle, and apply the crosstalk compensation function to the section of the three dimensional display to reduce the crosstalk of the three dimensional display from the viewing angle; and
where the processor is further configured to determine a reference point within the three dimensional display, and determine the viewing angle from the reference point to the viewpoint, wherein the viewing angle is a horizontal viewing angle, a vertical viewing angle, or both a vertical viewing angle and horizontal viewing angle from the reference point, where the reference point is a central point of the three dimensional display as a whole.

18. A system for reducing crosstalk for a three dimensional display, the system comprising:
a display configured to display three dimensional video; and
a processor in communication with the display, the processor being configured to determine a viewing angle between a section of the three dimensional display and a viewpoint of the three dimensional display, generate a crosstalk compensation function for the section of the three dimensional display, wherein the crosstalk function compensates for the crosstalk at the viewing angle, and apply the crosstalk compensation function to the section of the three dimensional display to reduce the crosstalk of the three dimensional display from the viewing angle;
wherein the section further comprises two adjacent portions;
where the processor is further configured to
determine a first viewing angle between the first adjacent portion and the viewpoint;
determine a second viewing angle between the second adjacent portion and the viewpoint;
where generating a crosstalk compensation function comprises:
generate a first crosstalk compensation function for the first adjacent portion to compensate for crosstalk at the first viewing angle;
generate a second crosstalk compensation function for the second adjacent portion to compensate for crosstalk at the second viewing angle;
apply the first crosstalk compensation function to the first adjacent portion; and
apply the second crosstalk compensation function to the second adjacent portion.

19. The system of claim 18, where first viewing angle and the second viewing angle are the viewing angles between the viewpoint and a center point for each of the two adjacent portions.

20. The system of claim 19, wherein the processor is further configured to scale the first crosstalk compensation function according to distance from the second adjacent portion to provide a smooth transition to the second crosstalk compensation function
